(19) United States
(12) Patent Application Publication
(10) Pub. No.: US 2015/0088536 A1
(43) Pub. Date: Mar. 26, 2015

(54) HEALTHCARE SYSTEM AND METHOD FOR ADJUSTING A PERSONALIZED CARE PLAN OF A USER

(71) Applicant: KONINKLIJKE PHILIPS N.V., Eindhoven (NL)

(72) Inventors: Eric Thelen, Budel (NL); Frank Wartena, Eindhoven (NL)

(21) Appl. No.: 14/482,544

(22) Filed: Sep. 10, 2014

(30) Foreign Application Priority Data
Sep. 24, 2013 (EP) 13185654.4

(51) Int. Cl. G06F 19/00

(52) U.S. Cl. CPC G06F 19/3456; G06F 19/3418
USPC 705/2

(57) ABSTRACT

The present invention relates to a healthcare system (10, 20) comprising a care plan unit (2) for obtaining a personalized care plan (13) for a user, said care plan defining a plurality of prescribed care plan elements to be adhered to by the user, a compliance score calculation unit (3) for calculating the user's compliance score indicating the user's compliance to his care plan based on measurements (14) of the user's adherence to prescribed care plan elements, and a care plan adjustment unit (4) for dynamically adjusting the user's care plan based on the user's calculated compliance score.

### FIELD OF THE INVENTION

The present invention relates to a healthcare system and a corresponding method, in particular for adjusting a personalized care plan of a user.

### BACKGROUND OF THE INVENTION

Home healthcare applications often work with a care plan that patients (hereinafter more generally referred to as “users”, i.e. whenever reference is made to “patient” it shall be understood more generally as “user”) have to follow in order to achieve the best possible effectiveness of their home healthcare program. A care plan may e.g. determine how patients are being educated and how they are being monitored. Usually, a care plan will require the patient to do a number of things (e.g. provide vital sign data, take their medicines, review an educational program, complete a survey, etc.), i.e. a care plan (generally being a specification of an intervention, with or without coaching) comprises a number of care plan elements (which are the things to be done) to be adhered to by a patient.

Patient's non-compliance to the care plan, e.g. specifying a chronic conditions therapy, decreases the care plan efficacy and exposes the patient to clinical destabilization, which can lead to exacerbating disease symptoms. Evidence from clinical trials and validated patient's and clinician's insights show that the most commonly identified cause of disease worsening, e.g. Heart Failure decompensation, is non-compliance with medication, low sodium diet, fluid restriction and physical activity. Non-compliance is the precipitating factor of exacerbation. Hence, patient's compliance to a care plan is a prerequisite for better clinical outcomes, e.g., reduced readmissions and mortality.

The care plan in home settings is usually presented to the patients on paper or via a telehealth system The home part of a telehealth system can be deployed on different types of devices, e.g. on a settop box connected to a TV, on a tablet or mobile phone or as a web portal. The telehealth system can be a stand-alone service or an embedded service in a patient portal which supports patients with personalized information and tools to improve their understanding of their health condition(s) and the benefits of compliance with their care plan.

### SUMMARY OF THE INVENTION

It is an object of the present invention to provide a healthcare system and method, by which a better motivation and adherence of the user to the care plan can be achieved.

In a first aspect of the present invention a healthcare system is presented comprising:

a care plan unit for obtaining a personalized care plan for a user, said care plan defining a plurality of prescribed care plan elements to be adhered to by the user,

a compliance score calculation unit for calculating the user's compliance score indicating the user's compliance to his care plan based on measurements of the user's adherence to prescribed care plan elements, and

a care plan adjustment unit for dynamically adjusting the user's care plan based on the user's calculated compliance score.

In a further aspect of the present invention a corresponding healthcare method is presented.

In a still further aspect of the present invention a healthcare system is presented comprising a processor and a computer-readable storage medium, wherein the computer-readable storage medium contains instructions for execution by the processor, wherein the instructions cause the processor to perform the steps of the healthcare method disclosed herein.

In yet further aspects of the present invention, there are provided a computer program which comprises program code means for causing a computer to perform the steps of the healthcare method disclosed herein when said computer program is carried out on a computer as well as a non-transitory computer-readable recording medium that stores therein a computer program product, which, when executed by a processor, causes the healthcare method disclosed herein to be performed.

Preferred embodiments of the invention are defined in the dependent claims. It shall be understood that the claimed method, computer program and medium have similar and/or identical preferred embodiments as the claimed system and as defined in the dependent claims.

The present invention is based on the idea to achieve maximum acceptance (or, more precisely, adherence/compliance) of the care plan by patients through personalization of the care plan since patients (and their environment) can be very different. Further, as the situation of patients (and their environment) can change over time, the present invention provides for dynamic adjustments of the care plan over time. It is therefore proposed to calculate a compliance score based on objectively observed patient behavior, to translate this compliance score into a measure for how much the patient can be trusted to follow his respective care plan and to modify the care plan accordingly. In general, patients, who can be trusted, will be managed via care plans that are less of a perceived burden for them.

While care plans are already frequently being used in home healthcare applications, they are only rarely being dynamically adjusted. Often they are adjusted when a new condition is diagnosed or after the patient has been hospitalized, but not on an ongoing and regular basis. Further, such adjustments are generally a result of an updated assessment of the patient's health condition. A concept in which the care plans are adapted based on observed patient compliance behavior is so far not known.

Thus, the proposed healthcare system and method provide an appropriate and dynamic care plan adjustment mechanism based on objective patient compliance behavior that enables that compliant patients are being rewarded for exhibiting the desired behavior. This is expected to lead to additional motivation for the patients to continue their compliant behavior. On the other hand, patients, who are not sufficiently compliant with their care plans, may experience a tighter control and additional care plan complexity/burden. For some of them, this will be necessary to support them with their home healthcare needs; for others, this will be a motivation to improve their compliance in order to again be managed by a more simple (and more easily manageable) care plan.

The care plan itself may be created by the healthcare system and method or may be predefined (created in advance and/or by a different system and input to the healthcare system and method.

In a preferred embodiment the compliance score calculation unit is configured to calculate the user's compliance score based on one or more of

the percentage of prescribed care plan elements adhered to by the user,

the timeliness of adherence of prescribed care plan elements by the user,

the amount of time required by a user for adhering to the respective prescribed care plan elements, and

the performance, amount and/or accuracy of adherence to the respective prescribed care plan elements by the user.

These parameters can generally be measured, e.g. automatically (i.e. without user interaction) or by requesting user input or user interaction) and generally reflect how much the user is following his personalized care plan. This information may be used to improve the accuracy of the compliance score. It is known that patients (people in general) are pretty bad at recalling exactly what they did and when, so asking a patient if he took his medication on time or if he did his exercises as prescribed is likely going to be misreported by the patient. This embodiment of the present invention thus enables to really measure what the patient did when and adjust the care plan dynamically. So it is both more reliable, because it doesn't depend on patient recall, and much more dynamic, because it can be adjusted in real time, not only while a patient visits his care provider.

Appropriate adherence measurement elements may be external elements (not belonging to the proposed healthcare system) or internal elements (belonging to the proposed healthcare system). Such adherence measurement elements may comprise one or more of

a user interface for requesting user input,

one or more vital sign measurement units for measuring one or more vital signs of the user,

a camera for monitoring the user,

a medication intake monitoring unit for monitoring the user's adherence to a medication intake scheme, and

a multimedia unit for providing multimedia content to the user.

Said adherence measurement elements may be implemented by one or more separate elements, but may also be integrated in other devices. For instance, a tablet or smartphone may be supplemented with separate measurement devices and a separate medication intake monitor to realize one or more of these adherence measurement elements.

According to another preferred embodiment the compliance score calculation unit is configured to calculate the user's compliance score based on one or more of

the user profile,

the health status of the user, in particular the type of disease of the user,

the complexity of the respective prescribed care plan elements,

user trend information indicating the user's general trend with respect to his adherence to the prescribed care plan elements and/or with respect to his health condition, and

the user's adherence to bonus exercises.

Information regarding these parameters is at least partly provided by the care plan itself or through input when creating the personalized care plan for the user. Other information may be obtained through measurements or calculations. This information may further be used to improve the accuracy of the compliance score.

In a practical implementation, the compliance score calculation unit is configured to compare the user's actual adherence to the respective prescribed care plan elements to the expected adherence to prescribed care plan elements, to determine adherence deviations between actual adherence and expected adherence and to calculate the user's compliance score based on the determined adherence deviations. This can be done for some or all care plan elements.

In a more advanced embodiment the compliance score calculation unit is configured to weight the determined adherence deviations according to the relevance of the related care plan element and to calculate the user's compliance score based on the weighted adherence deviations. In this way more freedom with respect to individual adjustments of the care plan are available.

The care plan adjustment unit is preferably configured to assign a compliance threshold score assigned to the prescribed care plan elements indicating the threshold of the user's compliance score below which the respective prescribed care plan element has to be adhered to by the user. It is thus able to assign a kind of priorities/status to the various care plan elements and to control which care plan elements should ultimately be followed by the user and which care plan elements are not necessarily mandatory but more optional. Consequently, rewards and penalties for following/not following care plan elements can be assigned according to the “priority”, i.e. based on the compliance threshold score.

In another embodiment the care plan adjustment unit is configured to adjust the frequency, intensity, type and/or number of prescribed care plan elements of the user's care plan based on the user's calculated compliance score. Thus, the care plan can generally be adjusted in various ways to individually assign rewards and penalties to the individual user.

Further, it is provided in an embodiment that the care plan adjustment unit is configured to change the status of prescribed care plan elements between optional and mandatory, to provide bonus care plan elements and/or to provide break periods during which the care plan is suspended based on the user's calculated compliance score. This also provides more freedom to individually adjust the care plan.

### BRIEF DESCRIPTION OF THE DRAWINGS

These and other aspects of the invention will be apparent from and elucidated with reference to the embodiment(s) described hereinafter. In the following drawings

FIG. 1 shows a schematic diagram of a first embodiment of a healthcare system according to the present invention,

FIG. 2 shows a schematic diagram of a first embodiment of a healthcare method according to the present invention,

FIG. 3 shows a schematic diagram of a second embodiment of a healthcare system according to the present invention, and

FIG. 4 shows a schematic diagram of a third embodiment of a healthcare system according to the present invention.

### DETAILED DESCRIPTION OF THE INVENTION

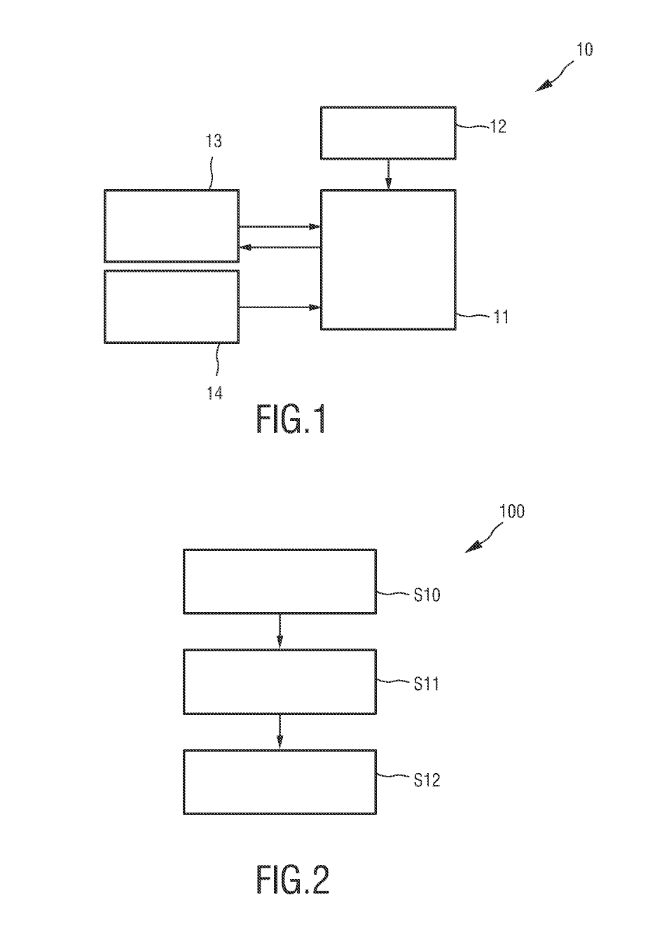

FIG. 1 shows a schematic diagram of a first embodiment of a healthcare system 10 according to the present invention. It comprises a processor 11 and a computer-readable storage medium 12. The computer-readable storage medium 12 contains instructions for execution by the processor 11. These instructions cause the processor 11 to perform the steps of a healthcare method 100 as illustrated in the flow chart shown in FIG. 2.

In a first step S10 a personalized care plan 13 for a user is obtained, said care plan defining a plurality of prescribed care plan elements to be adhered to by the user. Said care plan may be predefined and received by the system 10 or may be generated by the same system 10 in an initial step. For instance, a central server of the system 10 can generate the care plan or receive it from a care provider. In a second step S11 the user's compliance score indicating the user's compliance to his care plan based on measurements 14 of the user's adherence to prescribed care plan elements is calculated. In a third step S12 the user's care plan is dynamically adjusted based on the user's calculated compliance score.

The proposed healthcare system and method enable dynamical adjustments of personalized care plans for individual users, which are influenced by how much the system/method believes (at any given time) that the users can be trusted to be compliant (with their care plans). This user/patient trust measure (called compliance score herein) is calculated based on objectively observed patient behavior.

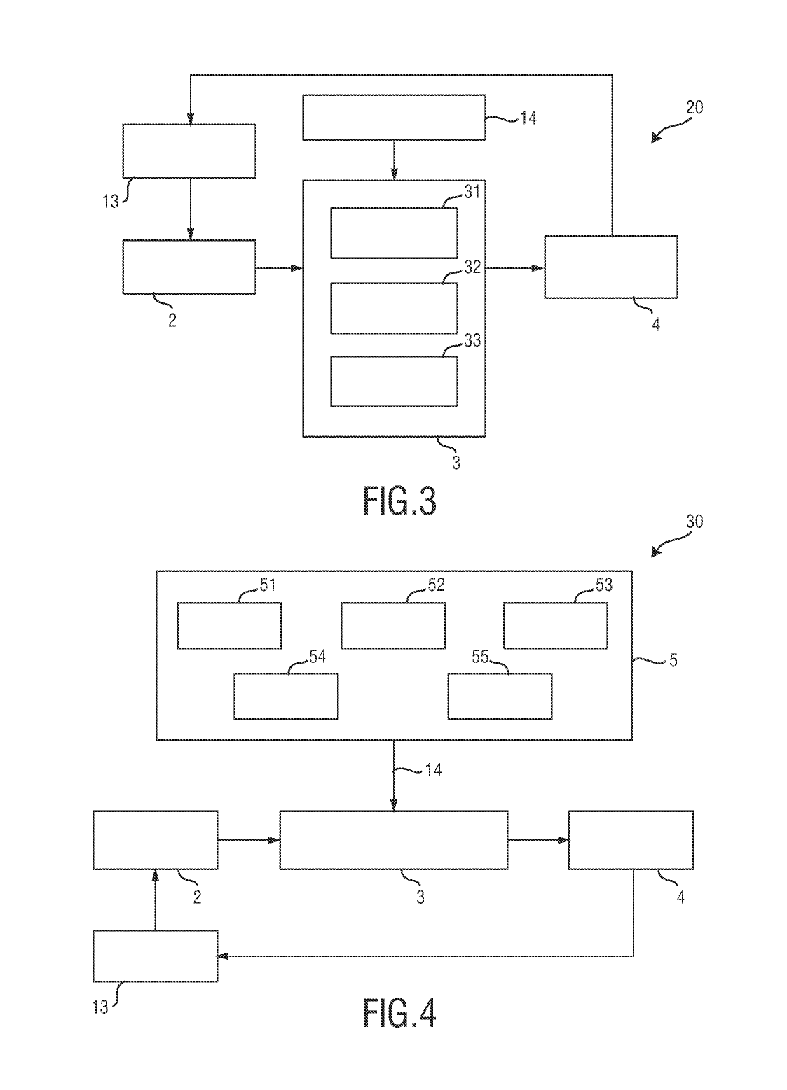

FIG. 3 shows a schematic diagram of a second, more detailed embodiment of a healthcare system 20 according to the present invention, by way of which more details of the present invention and of preferred embodiments and optional elements of the system will be explained hereinafter.

The healthcare system 20 comprises a care plan unit 2 for obtaining a personalized care plan 13 for a user, said care plan defining a plurality of prescribed care plan elements to be adhered to by the user, a compliance score calculation unit 3 for calculating the user's compliance score indicating the user's compliance to his care plan based on measurements 14 of the user's adherence to prescribed care plan elements, and a care plan adjustment unit 4 for dynamically adjusting the user's care plan based on the user's calculated compliance score. The elements of the healthcare system 20 may be implemented separately as hardware and/or software elements. Said healthcare system 20 may for instance, be implemented on a server of a care giver, a hospital or a special service provider. They may also be provided online, e.g. as a service in the cloud. On the patient side a patient device (e.g. smartphone, PC, laptop, tablet, etc.) is provided that interacts with the healthcare system in case of a connected healthcare system, or all functionality could be integrated into the patient device in case of a standalone healthcare system, such as a smartphone app.

The care plan unit 2 may be implemented as an interface for receiving or retrieving a (predefined) care plan, e.g. from a storage unit or from an external provider (e.g. a caregiver, a physician, a hospital, a pharmacist, etc.). The interface may thus be a reader or drive unit of a computer for reading a data carrier or may be a communication interface like a LAN or WLAN interface or a reception antenna for receiving mobile communications. Further, the interface may be a software module for receiving the care plan in digital form. In an alternative embodiment the care plan unit 2 may be implemented as a processing unit for creating the care plan for the particular user of the healthcare system based on all necessary information about the user (e.g. the user's health status, medication scheme, diagnosis, therapy, prior diseases, desired actions to be performed by the user, etc.). Generally, such a care plan is defined by the user's caregiver or physician, but the creation of the care plan may also be, at least partly, automated as e.g. described in US 2012/030156 A1.

The compliance score calculation unit 3 calculates the compliance score in such a way that it reflects the patient's compliance behavior as accurately as possible. An exemplary suitable algorithm determines a compliance percentage as the percentage of care plan tasks that have been completed at the expected time. Delayed tasks would lead to “penalties” depending on how significantly they are delayed. Tasks that are not carried out at all lead to significant “penalties”. Patients, who have a reason to not be compliant with a certain care plan element, may be able to explicitly ask for a rescheduling, to avoid the associated “penalties”.

In preferred embodiments the compliance score calculation unit 3 is configured to realize one or more of the following functions and comprises one or more of the following modules:

i) a task tracking module 31: This module records the actual actions of the patient in an appropriate way, so that they can later be matched against the care plan and checked for compliance. Many of the actions can be tracked in electronic ways via the system, but for some actions the patient may be asked to self-report on his/her actions.

ii) a care plan matching module 32: This module compares the expected behavior (care plan) against the actual behavior (tracking result) and provides a report on all relevant deviations. Potentially, this module can already flag unusual situations such as complete non-compliance, which would indicate that the patient does not participate at all, or 100% perfect compliance, which would potentially indicate that the system is somehow being manipulated.

iii) a compliance score calculation module 33: This module calculates, based on the output from the care plan matching module 32, the actual compliance score. The various compliance deviations can receive different weights, depending on the relevance of the specific task for the overall outcome for this specific patient.

The actual calculation of the compliance score may be made dependent on one or more of the following parameters:

a) disease type: Patient compliance is more critical for some diseases than it is for others. For the more critical diseases, the “penalties” for non-compliance in the compliance score calculation should be higher than for the less critical diseases. A disease-specific compliance score calculation algorithm can be foreseen, so that even specific types of compliance (e.g. medication intake, vital sign measurements, learning modules) can have a disease-specific influence on the result.

b) patient profile: The compliance score calculation can depend on the profile of the specific patients. Via suitable profiling mechanisms (e.g. via a scientifically validated questionnaire method), different patient types can be identified. For some patients, being compliant will be inherently much easier than for others. A compliance score calculation method that is influenced by the patient profile can take this into account.

c) task timing: The compliance score calculation can be influenced by when a specific task is actually being carried out, as compared to when the task should have been carried out. A better match between the desired timing and the actual timing will lead to a higher compliance score.

d) task completion: The compliance score calculation can be influenced by how long it takes a patient to actually complete a task. If this takes much longer than expected, then it is possible that the patient got distracted and did not focus on the task, which should then lead to a lower compliance score.

e) task performance: If it can be evaluated how a patient has performed a certain task, then this can also influence the compliance score calculation. A better task performance (e.g. a more accurate questionnaire result at the end of a learning module) should lead to a higher compliance score.

f) task complexity: Tasks with a higher complexity may have a different influence on the compliance score calculation than tasks with a lower complexity. Many ways of accomplishing this can be considered. It would, e.g., be possible to associate low complexity tasks with possible compliance score penalties and high complexity tasks with possible compliance score bonuses. Patients would then not be “punished” if they had problems with the high complexity tasks, as long as they at least diligently perform the low complexity tasks.

g) patient trend: The overall patient trend (specifically with respect to compliance, but potentially also in general with respect to the patient's health condition) can influence the compliance score calculation as well. The compliance score calculation is preferably implemented in such a way that it tries to reinforce positive trends (e.g. by “forgiving” small mistakes without significant “penalties” if the overall trend is positive) and to interrupt negative trends (e.g. by “punishing” worsening behaviors with accelerating toughness over time).

h) previous compliance: The compliance score calculation can have a relatively long time window over which it would aggregate. This would imply that compliance behavior in the past is still relevant for the current score—until the specific observation moves out of the “sliding” time window. As a result, the patient would be motivated to stay compliant over a longer period of time (in order to achieve the best possible compliance score).

i) bonus exercises: The system could offer the patient specific and suitable bonus exercises, which the patient can use to improve the compliance score. These exercises would typically be useful, but not essential for the patient's care plan. Completing these exercises would lead to a higher compliance score, but there would be no “penalties” if the patient does not complete them.

There exist various embodiments for the care plan adjustment unit 4 for dynamically adjusting the user's care plan based on the user's calculated compliance score. One or more of the following mechanisms may be applied:

A) explicit mapping: With this mechanism the care plan does explicitly indicate for each care plan element a “compliance threshold score”. The patient will have to carry out the respective element, if his compliance score is below the compliance threshold score. For many care plan elements, which are mandatory for all patients, the compliance threshold score will be “100%”, meaning that those elements always have to be carried out.

B) frequency adjustments: With this mechanism, the frequency of required activities in the care plan will be adjusted according to the compliance score of the respective patient. For example, highly compliant patients may only have to go through one educational module per week, while non-compliant patients may be asked to review one educational module per day.

C) intensity adjustments: With this mechanism, the intensity of activities will be reduced for compliant patients. For example, highly compliant patients may only have to provide a few survey responses on a certain day, while non-compliant patients may be asked to record a full set of vital sign measurements.

D) patient choice: With this mechanism, compliant patients will be given a choice to leave out elements of the care plan and they can decide for themselves what they want to skip. The amount of elements that patients are allowed to leave out depends on the patient's compliance score, which is also reduced as a result of skipping these elements and needs to subsequently be raised again by being compliant again. It is possible that doctors and nurses will not like this variant as it introduces are certain level of “randomness” and thereby reduces their level of control.

E) bonus elements: With this mechanism, compliant patients are rewarded by additional care plan elements, which non-compliant patients do not receive. This could be a particularly funny video, a motivational audio file or an educational element providing additional learning opportunities, which would likely provide too much information for an already non-compliant patient.

F) care plan vacation: With this mechanism, a care plan would be temporarily suspended for a highly compliant patient, so that the patient can take a short “vacation” from having to follow the care plan.

As a further variant of the overall concept, separate compliance scores are calculated for separate care plan areas (i.e. groups of one or more related care plan elements, which are e.g. directed to the same health goal), e.g. medication intake, vital sign measurements and education. Those separate compliance scores then only influence the care plan in the respective care plan areas.

FIG. 4 shows a schematic diagram of a third embodiment of a healthcare system 30 according to the present invention. According to this embodiment the system 30 further comprises adherence measurement elements 5 for measuring the user's adherence to prescribed care plan elements. In other embodiments of the healthcare system such measurement elements are not part of the system itself, but are external elements. The adherence measurement elements 5 are, separately or commonly, be coupled to the compliance score calculation unit 3.

The adherence measurement elements 5 may include one or more of the following:

1) a user interface 51: this is preferably provided for requesting user input, e.g. for getting responses from the user to inquiries, questionnaires, etc., for instance to get information about the percentage of prescribed care plan elements adhered to by the user, the timeliness of adherence of prescribed care plan elements by the user and/or the amount of time required by a user for adhering to the respective prescribed care plan elements. Not for all care plan elements this information can be measured automatically, but some care plan elements (e.g. if a patient has read prescribed instructions or has performed prescribed physical exercises) require user input to get this information. Such a user interface 51 may e.g. be a computer or tablet with input means (e.g. a keyboard and/or a display such as a touch screen).

2) one or more vital sign measurement units 52: these are preferably provided for measuring one or more vital signs of the user, such as temperature, blood pressure, blood sugar, SpO2, heart rate, breathing rate, physical activity, etc. Such vital sign measurement units may be conventional means for measuring the respective vital sign, which may be coupled to a patient monitor that transmits the collected vital sign information to the compliance score calculation unit 3. In another embodiment the vital sign measurement unit may include a remote photo-plethysmogram (remote PPG) unit for extracting certain vital signs from camera images of the patient in a known manner.

3) a camera 53 for monitoring the user: this may be provided to monitor what the user is doing, e.g. if he performs prescribed physical exercises at the right time and in the right amount and intensity. Another purpose may be the use for obtaining skin images of the user for deriving vital signs of the user using the known remote PPG technique.

4) a medication intake monitoring unit 54: this is provided for monitoring the user's adherence to a mediation intake scheme and may e.g. be realized by a medicine dispenser which automatically outputs or at least indicates a medicine item at the moment when the patient has to take the medicine item and which may also detect if the medicine item has indeed been taken out of the dispenser (and presumably been taken by the patient). For instance, a sensor (as e.g. currently described by Proteus Digital Health at http://www.proteusdigitalhealth.com/technology/digital-health-feedback-system) could be used to detect if a patient has swallowed a medication.

5) a multimedia unit 55: this is provided for providing multimedia content to the user, e.g. to show educational or guidance videos or for displaying instructions to the user.

The proposed healthcare system can e.g. be used as a stand-alone telehealth system or as embedded telehealth service in a patient portal such as the Philips My WellBook. Such telehealth systems have been briefly explained above in the background section and are generally known.

A telehealth system generally comprises a patient device (e.g. tablet, smartphone or dedicated device) handling the interactions with the patient and connecting to the measurement devices (which in some cases do not connect to the patient device, but connect directly or via a router to the internet). A telehealth system further generally comprises a server which hosts all of the data, receives the measurements and patient responses, runs the care plan and provides alerts based on the collected data. Said server may implement the care plan unit 2, the compliance score calculation unit 3 and the care plan adjustment unit 4. Still further, a clinical user interface is generally provided which is used by the care providers to review the patient status and data.

Modifications to the care plan may be done on the server as the server has the full picture of the patient status. For some modifications of the care plan approval from the care provider might be needed. So instead of the server directly changing the care plan, it may be the case that the care provider is notified via the clinical user interface that the patient's compliance score has changed (e.g. has become very high) and that therefore the care plan can be adjusted in a proposed way.

Due to legal reasons it might even be necessary to get approval from a care provider before allowing a change to the care plan. Also in this case there would first need to be a notice to the care provider of the patient indicating that the patient is very compliant (or less compliant) and proposing that the care plan is adjusted in a certain way. The care provider would then need to approve that change such that it is the care provider making the decision and being responsible for it and not the system. The change of the care plan could then be made by the care provider or the server.

By the proposed healthcare system and method the care plan of a user/patient can be individually adjusted. It is possible that patient compliance will be rewarded by reducing the complexity of the care plans (e.g. ask the patient less often to fill in surveys, take measurements less often, etc.) for compliant patients (e.g. patients who fill in surveys, watch educational videos, take measurements), likely leading to higher patient satisfaction. Non-compliance will increase the overall effort for non-compliant patients, which will also provide additional control mechanisms for the healthcare provider that now gets even more data from those patients or can detect complete non-compliance even earlier. The adjustments of the personalized care plans (for individual patients) are influenced by how much the system believes (at any given time) that the patients can be trusted to be compliant (with their care plans). This patient trust measure is calculated based on objectively observed patient behavior. Thus, not only a single care plan element, but the whole care plan is thus made dynamic.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory storage medium, such as an optical storage medium or a solid-state storage medium supplied together with or as part of other hardware, but may also be distributed in other forms, such as via the Internet or other wired or wireless telecommunication systems.

Furthermore, the different embodiments can take the form of a computer program product accessible from a computer usable or computer-readable storage medium providing program code for use by or in connection with a computer or any device or system that executes instructions. For the purposes of this disclosure, a computer usable or computer-readable storage medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

The computer usable or computer-readable storage medium can be, for example, without limitation, an electronic, magnetic, optical, electromagnetic, infrared, or semiconductor system, or a propagation medium. Non-limiting examples of a computer-readable storage medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer-readable storage medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

1. A healthcare system comprising
a care plan unit for obtaining a personalized care plan for a user, said care plan defining a plurality of prescribed care plan elements to be adhered to by the user,
a compliance score calculation unit for calculating the user's compliance score indicating the user's compliance to his care plan based on measurements of the user's adherence to prescribed care plan elements, and
a care plan adjustment unit for dynamically adjusting the user's care plan based on the user's calculated compliance score.

2. The healthcare system as claimed in claim 1, wherein the compliance score calculation unit is configured to calculate the user's compliance score based on one or more of
the percentage of prescribed care plan elements adhered to by the user,
the timeliness of adherence of prescribed care plan elements by the user,
the amount of time required by a user for adhering to the respective prescribed care plan elements, and
the performance, amount and/or accuracy of adherence to the respective prescribed care plan elements by the user.

3. The healthcare system as claimed in claim 1, further comprising adherence measurement elements for measuring the user's adherence to prescribed care plan elements, in particular for measuring one of more of
the percentage of prescribed care plan elements adhered to by the user,
the timeliness of adherence of prescribed care plan elements by the user,
the amount of time required by a user for adhering to the respective prescribed care plan elements, and
the performance, amount and/or accuracy of adherence to the respective prescribed care plan elements by the user.

4. The healthcare system as claimed in claim 3, wherein said adherence measurement elements comprise one or more of
a user interface for requesting user input,
one or more vital sign measurement units for measuring one or more vital signs of the user,
a camera for monitoring the user,
a medication intake monitoring unit for monitoring the user's adherence to a mediation intake scheme, and
a multimedia unit for providing multimedia content to the user.

5. The healthcare system as claimed in claim 1, wherein the compliance score calculation unit is configured to calculate the user's compliance score based on one or more of
the user profile,
the health status of the user, in particular the type of disease of the user,
the complexity of the respective prescribed care plan elements,
user trend information indicating the user's general trend with respect to his adherence to the prescribed care plan elements and/or with respect to his health condition, and
the user's adherence to bonus exercises.

6. The healthcare system as claimed in claim 1, wherein the compliance score calculation unit is configured to compare the user's actual adherence to the respective prescribed care plan elements to the expected adherence to prescribed care plan elements, to determine adherence deviations between actual adherence and expected adherence and to calculate the user's compliance score based on the determined adherence deviations.

7. The healthcare system as claimed in claim 6, wherein the compliance score calculation unit is configured to weight the determined adherence deviations according to the relevance of the related care plan element and to calculate the user's compliance score based on the weighted adherence deviations.

8. The healthcare system as claimed in claim 1, wherein the care plan adjustment unit is configured to assign a compliance threshold score assigned to the prescribed care plan elements indicating the threshold of the user's compliance score below which the respective prescribed care plan element has to be adhered to by the user.

9. The healthcare system as claimed in claim 1, wherein the care plan adjustment unit is configured to adjust the frequency, intensity, type and/or number of prescribed care plan elements of the user's care plan based on the user's calculated compliance score.

10. The healthcare system as claimed in claim 1, wherein the care plan adjustment unit is configured to change the status of prescribed care plan elements between optional and mandatory, to provide bonus care plan elements and/or to provide break periods during which the care plan is suspended based on the user's calculated compliance score.

11. A healthcare method comprising the steps of:
obtaining a personalized care plan for a user, said care plan defining a plurality of prescribed care plan elements to be adhered to by the user,
calculating the user's compliance score indicating the user's compliance to his care plan based on measurements of the user's adherence to prescribed care plan elements, and
dynamically adjusting the user's care plan based on the user's calculated compliance score.

12. Computer program comprising program code means for causing a computer to carry out the steps of the method as claimed in claim 11 when said computer program is carried out on the computer.

13. A healthcare system comprising a processor and a computer-readable storage medium, wherein the computer-readable storage medium contains instructions for execution by the processor, wherein the instructions cause the processor to perform the steps of the healthcare method as claimed in claim 11.
